(19) United States
(12) Patent Application Publication
(10) Pub. No.: US 2024/0036433 A1
(43) Pub. Date: Feb. 1, 2024

(54) TUNABLE MID-IR TRANSMITTER FOR HIGH-SPEED FREE SPACE COMMUNICATIONS

(71) Applicant: MILC, LLC, Tucson, AZ (US)

(72) Inventors: Valery Temyanko, Tucson, AZ (US); Leonid Kotov, Tucson, AZ (US)

(21) Appl. No.: 17/875,224

(22) Filed: Jul. 27, 2022

(51) Int. Cl. G02F 1/35; H01S 3/094; H01S 3/16; H01S 3/083; H01S 3/136; H01S 3/067; G02F 1/355

(52) U.S. Cl. CPC G02F 1/3534; H01S 3/094076; H01S 3/1643; H01S 3/083; H01S 3/136; H01S 3/1623; H01S 3/094038; H01S 3/06716; H01S 3/1618; G02F 1/3558; G02F 1/3551

(57) ABSTRACT

Systems, devices, and methods of the present invention provide for the effective generation of high-speed modulated light using difference frequency generation (DFG). Modulated light in the mid-IR region may be generated in an optical resonator with a DFG device and having a Q factor greater than about 50 for a signal light with a wavelength in the range between 1350 and 1550 nm. A DFG device may generate the modulated mid-IR light by collinear passage of the intracavity signal light and a modulated pump light having a wavelength in the range between 1000 and 1100 nm through the DFG device. The modulated pump could be used for pumping both a signal lasing media and a DFG device at the same time.

### FIELD OF THE INVENTION

The present invention relates to tunable mid-IR transmitters for high-speed free space communications. More specifically, the present invention relates to transmitters which generate high-speed modulated light using difference frequency generation (DFG).

### BACKGROUND OF THE INVENTION

Mid infrared long-range optical free space communication transmitters require relatively narrow linewidth (e.g. <1 nm), high power (e.g. 1-10 W) outputs in 3.8-4.1 μm atmospheric window. The laser sources should be capable of providing high-speed modulation to transfer data at >1 Gbit/s. Additionally, these lasers should have an ability to work at any wavelength in the window of interest to operate at different channels within such windows. Current approaches to generate light in the required spectral ranges are quantum cascade lasers (QCLs); single-pass or signal/idler resonant cavity-based optical parametric oscillators (OPOs); and supercontinuum fiber sources.

However, all these approaches have their limitations. Supercontinuum lasers provide radiation with a broad spectrum and low spectral power density. Although QCLs with required power have been demonstrated and even fast modulated, none of those lasers operate in the required 3.8-4.1 μm atmospheric transmission window.

Difference frequency generation (DFG) is a convenient approach to make lasers for mid IR optical communication transmitters. DFG is a process where pump photons in nonlinear media generate signal and idler photons at lower frequencies. The frequencies of these three waves are related by the following equation: vₚᵤₘₚ=v_{signal}+v_{idler}. To stimulate efficient process high pump and signal power densities are desirable. The overall efficiency of DFG is proportional to the product of Iₚᵤₘₚ×I_{signal} (when the depletion of pump is low), where I_{pump/signal} is a pump/signal intensity.

There are few common approaches for DFG:

1. Single pass. As it is shown in FIG. 1 in a continuous wave (CW) single-pass configuration the radiation from two lasers operated at pump and signal wavelengths are first spatially combined and then launched into nonlinear crystal where DFG takes place. The single-pass schemes were demonstrated to be capable of generating few Watts of IR light via FDG, however, they require high pump and signal powers, and therefore overall wall-plug efficiency is low. For instance, 40 W at 1064 nm and 30 W at 1550 nm may be required to produce 3.5 W at 3.6 um. An advantage of this approach is the ability to modulate either the pump or signal light, so that the generated idler signal will be modulated in the same manner.

2. Signal or signal/idler resonant cavity. Another standard approach for DFG systems is when it is done inside cavities resonant at signal or idler or both signal and idler wavelengths. An example of a DFG ring cavity operated in such a regime is presented in FIG. 2. Both signal and idler light in such a scheme is generated due to DFG process. For example, the cavity might have a high Q-value at a signal wavelength. This allows building high intracavity signal power density, thus improving the DFG process efficiency without a need for a separate signal laser, simplifying their design.

However, this configuration limits the ability for the fast modulation due to the buildup time that is required for signal or idler. This buildup time would limit the modulation frequency to kHz-MHz range.

3. Pump laser cavity. There were several works on sum frequency generation similar to that shown in FIG. 2 but with cavities having lasing media for pump wavelength and extra-cavity signal going through the DFG crystal that was inside the cavity as well. In these configurations, the signal can be modulated, thus providing modulation of the generated light, that is typically at UV spectral range. However, it is believed that no DFG lasers have been demonstrated with the same operation principle.

4. Pulsed lasers. Pulsed lasers operating in kHz-to-MHz pulse repetition frequency and ns-μs pulse duration ranges allow achievement of ˜1 kW-100 MW peak power with only a few Watts of average power. Pump and/or signal light with such a peak power result in efficient IR DFG. However, pulse trains with such repetition frequencies cannot provide fast (GHz) modulation. At the same time, high-frequency (˜GHz repetition rate) lasers can provide high modulation speed but their peak power is low, so they show little enhancement compared to the quasi-CW modulated lasers described above.

### BRIEF SUMMARY OF THE INVENTION

It is an objective of the present invention to provide systems, devices, and methods that allow for effective generation of high-speed modulated light using DFG, as specified in the independent claims. Embodiments of the invention are given in the dependent claims. Embodiments of the present invention can be freely combined with each other if they are not mutually exclusive.

In some embodiments, the present invention uses DFG inside the cavity where the signal is generated inside lasing media inside the cavity that is pumped by either a modulated pump or a separate pump.

The proposed mid infrared laser may consist of four primary elements: (1) a cavity with a Cr:YAG crystal operating at the signal wavelength λ_{signal} from 1350-1550 nm spectral range, (2) an external pump source operating at λₚᵤₘₚ in 900-1150 nm spectral range, radiation of which can be fast modulated, (3) a nonlinear crystal placed into the cavity and configured for phase matching condition for DFG, and (4) a wavelength tuning element in the cavity that allows changing λ_{signal}. The beam of the pump and signal are collinearly propagating through the nonlinear crystal. The nonlinear crystal parametrically converts pump and signal light into mid infrared light (idler) with optical frequency equal to the difference between pump and signal frequencies (FIGS. 3-10).

The laser cavity has low optical loss and high Q value at the signal wavelength, allowing high circulating signal power inside the cavity and being non-resonant at pump or generated idler. Thus, the key advantage of high circulating power at λ_{signal} is highly efficient generation of λ_{idler} that mimics the modulation given to the λₚᵤₘₚ. The Cr:YAG crystal can be pumped either by a separate source at 900-1150 nm, such as a diode or fiber laser, or by residual power from the modulated pump source that was not absorbed by the DFG crystal. As an example, 3997 nm idler output will have the same modulation as a 1064 nm pump (assuming 1450 nm signal).

One of the unique and inventive technical features of the present invention is the use of a Cr:YAG crystal inside an optical resonator to generate a high circulating power of signal light with a wavelength tunable between 1350 and 1550 nm. Without wishing to limit the invention to any theory or mechanism, it is believed that the technical feature of the present invention advantageously provides for difference frequency generation of an idler output which may be tuned from 3100 to 5100 nm in wavelength. None of the presently known prior references or work has the unique inventive technical feature of the present invention.

The prior references teach away from the present invention. For example, the more intuitive approach proposed before by other groups would be to make a laser cavity operating at pump wavelength, and use an external modulated source at the signal wavelength. By doing this one would avoid depletion of the pump and the resulting significant limitation of the efficiency of the laser. In the counterintuitive approach of the present invention, the cavity works at the signal wavelength, and the external laser at pump wavelength. This limits the maximum efficiency of the laser to be λₚᵤₘₚ/λ_{idler} due to pump depletion (e.g. ˜27% for 1064 nm pump and 3997 nm idler). So, for example, from 100 W of pump no more than 27 W of idler can typically be generated. For a standard scheme much higher intracavity pump power can be achieved with the same system's power consumption, so the limit of the idler power will be higher than 27 W. However, the strategy of the present invention has advantages that compensate this drawback:

First, the photorefractive damage threshold of the DFG crystal is higher at the signal wavelength than at the pump wavelength. In order to increase the DFG efficiency the present invention uses intracavity generation of signal (not the most obvious pump intracavity generation) because the photorefractive damage of the DFG crystal would limit the circulating power that could be used. For example, high power light around 1064 nm creates doubled frequency light inside a DFG device, which may cause photo-refractive damage to the DFG device. In comparison, doubled frequency light from around 1450 nm does not possess enough energy to inflict such damage, thus increasing the power scalability of the approach of the present invention. As such, by increasing the signal circulating power higher output power may be achieved.

Second, the absorption of the DFG is typically orders of magnitude lower at signal wavelength, compared to the pump wavelength. Thus, the present invention allows circulation of a lot more power at the signal wavelength (instead of the pump wavelength) while generating about the same amount of parasitic heating inside the DFG crystal. This parasitic heating in DFG crystal creates temperature gradients that cause de-phasing and results in dropping the DFG efficiency. So, the present invention causes less heat problems and better efficiency due to the reduction of de-phasing.

Third, the unique combination of a Yb-doped fiber laser and Cr:YAG allows use of a single 1064 nm light as both the laser pump for Cr:YAG (to generate 1450 nm) and also the DFG pump for the non-linear DFG crystal. This design provides both diffraction limited light for the Cr:YAG and automatic collinear propagation of pump and signal in the DFG crystal, which increases the overall efficiency even further.

To summarize, the present invention's use of intracavity signal allows for higher output power than previous designs using an intracavity pump.

Furthermore, the inventive technical feature of the present invention contributed to a surprising result. For example, devices of the present invention with depleted pump and intracavity signals have achieved the same efficiency as prior art examples with almost un-depleted pump intracavity and external signals.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The features and advantages of the present invention will become apparent from a consideration of the following detailed description presented in connection with the accompanying drawings in which:

FIG. 1 shows a block diagram of an example single pass difference frequency generation (DFG) device.

FIG. 2 shows a block diagram of an example signal or signal/idler cavity-based DFG device.

FIG. 3 shows a block diagram of an embodiment of the present invention with a folded linear cavity having a simple V shape.

FIG. 4 shows a block diagram of an embodiment of the present invention with a folded linear cavity having an additional pump laser source for the Cr:YAG crystal.

FIG. 5 shows a block diagram of an embodiment of the present invention with a folded linear cavity having a split pump signal.

FIG. 6 shows a block diagram of an embodiment of the present invention with a folded linear cavity having a split pump signal and two separate ytterbium-doped fiber amplifiers (YDFA).

FIG. 7 shows a block diagram of an embodiment of the present invention with a ring cavity having a simple bow-tie shape.

FIG. 8 shows a block diagram of an embodiment of the present invention with a ring cavity having an additional pump laser source for the Cr:YAG crystal.

FIG. 9 shows a block diagram of an embodiment of the present invention with a ring cavity having a split pump signal.

FIG. 10 shows a block diagram of an embodiment of the present invention with a ring cavity having a split pump signal and two separate ytterbium-doped fiber amplifiers.

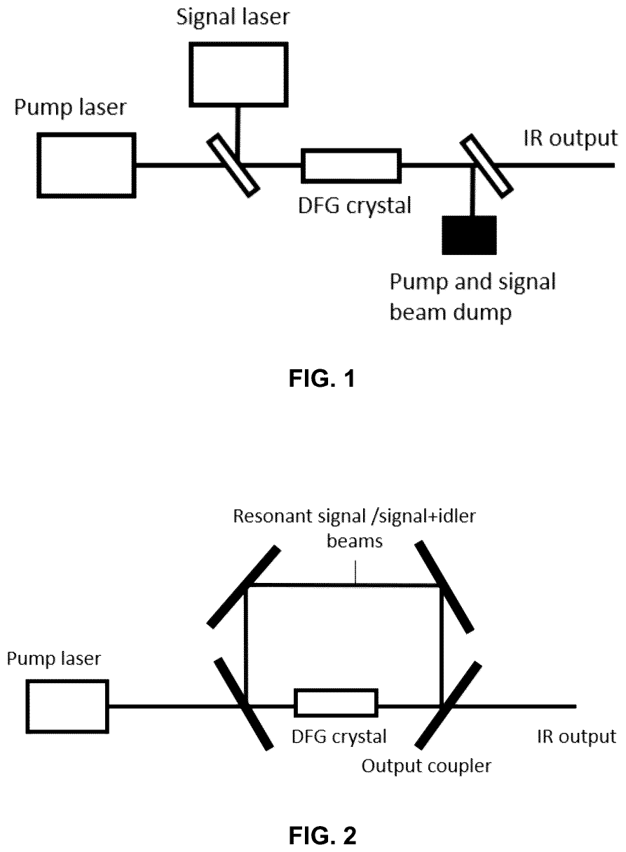

### DETAILED DESCRIPTION OF THE INVENTION

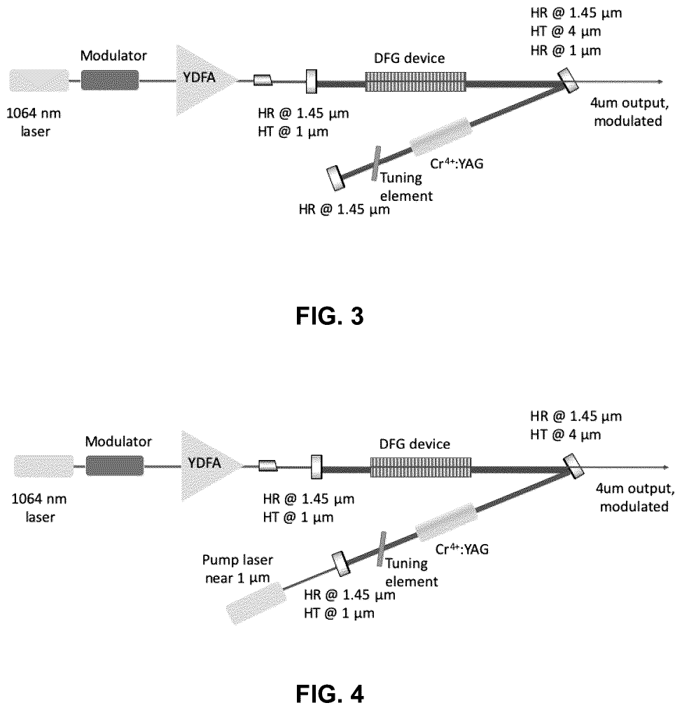

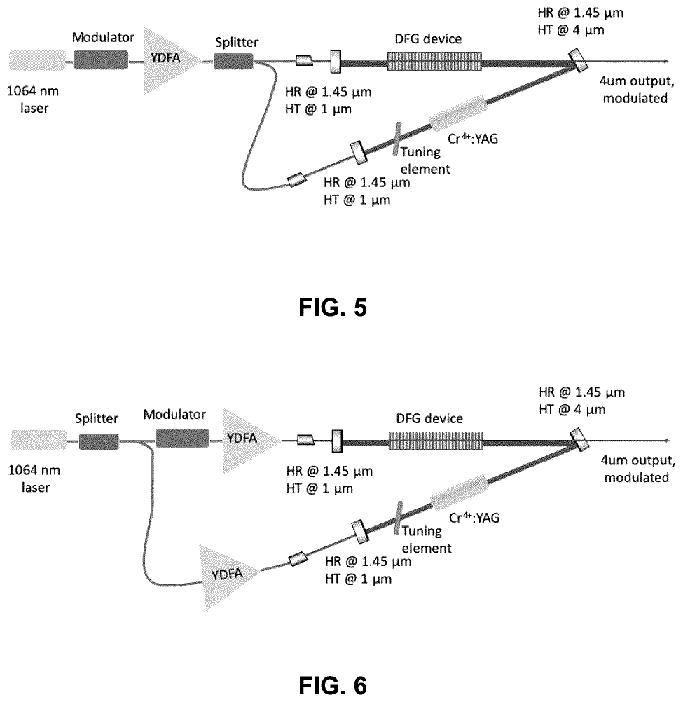

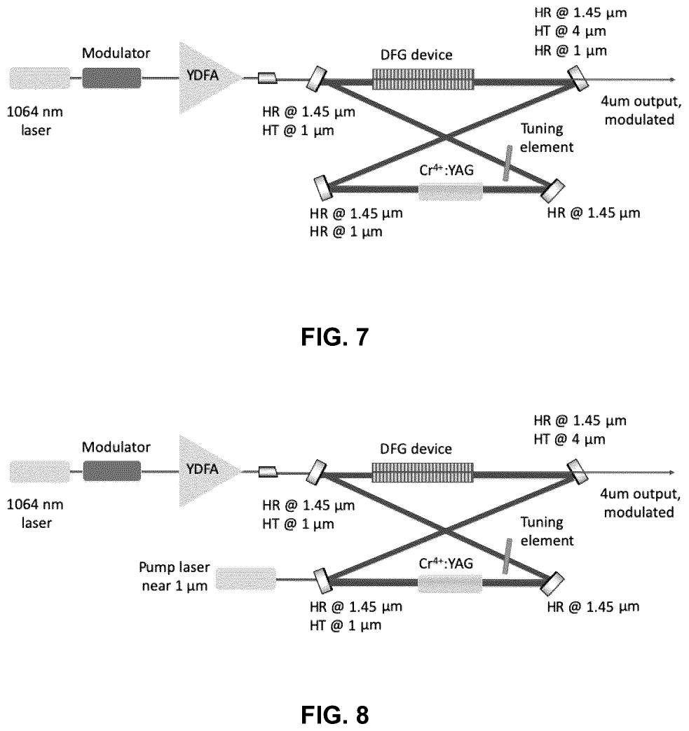

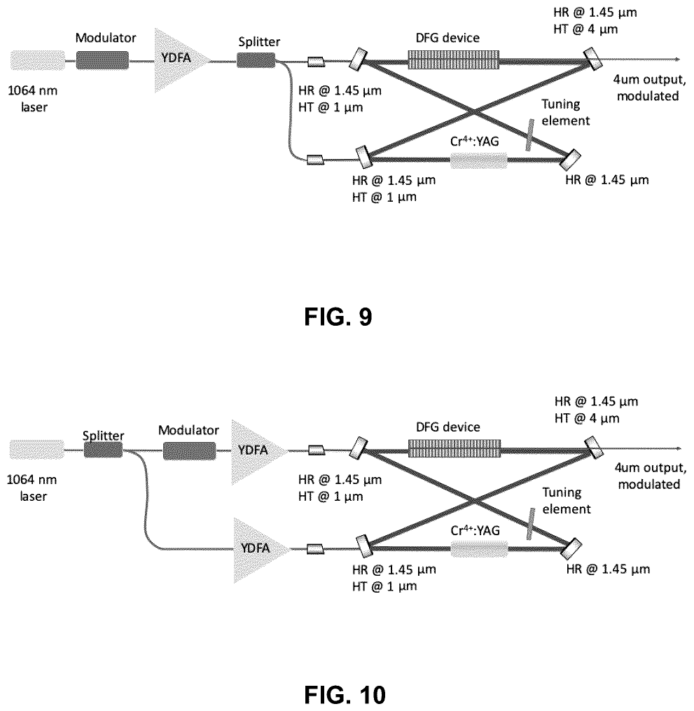

For ease of understanding of the invention, its principle is explained with non-limiting examples of both folded linear cavity and ring cavity designs (FIGS. 3-10). While folded or linear cavities are simpler and more compact, ring or bow-tie cavities allow for better engineering of the fundamental sizes of the beam in the cavity. Moreover, ring or bow-tie cavities allow for unidirectional intracavity operation, which doubles DFG efficiency. It should be noted that different pump, signal, and idler wavelengths, as well as different cavity configuration can also be realized. For the efficient nonlinear conversion, high intensities of the input light are desired. To realize high intensity of the signal, the lasing crystal may be placed in the laser cavity with high finesse (>50) at 1450 nm. The DFG pump at 1064 nm may be generated by a fiber coupled seed diode, which is then modulated and amplified using one or multiple-stage ytterbium-doped fiber amplifier (YDFA) or Nd-doped fiber amplifier. Then it may be injected into a nonlinear crystal (PPLN, for example) through one of the cavity mirrors which may be specifically coated for high transmission at the pump wavelength while maintaining high reflectivity at the signal wavelength. The cavity may contain a Cr:YAG crystal (lasing media) that is pumped either by a separate source with wavelength near 1 μm or by a 1064 nm light that is left after DFG crystal or both.

Cr:YAG is a low-gain laser material with low lifetime (˜4 μs). Thus, efficient laser operation is possible only with high intracavity power. This is exactly what is used in this invention—high Q cavity to generate high intracavity power for efficient DFG. There were several demonstrations of Cr:YAG lasers operating in 1300-1550 nm operating in high-finesse cavities. About 250 W intracavity power has been demonstrated with pump power of only 6.6 W at 1.05 μm. No significant pump-induced bleaching, damage or polarization anisotropy was observed in that experiment. Also, the linear dependence of the output power versus pump power indicates that the output power, and thus intracavity power, can further be increased with higher pumping.

The nonlinear crystal ideally should have as large as possible nonlinear optical coefficient, low optical loss, and high-power handling capability. Two periodically poled crystals lithium niobate (PPLN) or tantalate (PPLT) were identified as very good candidates for our system. PPLT might be slightly preferable due to its higher power handling capability compared to more common lithium niobate. Numerical simulation shows that PPLN of reasonable length (25-50 mm) would generate 5-10 W of idler when 100 W of intracavity signal at 1450 nm and about 20 W peak power of modulated 1064 nm pump (0.06-0.1 mm diameter beams) are collinearly incident on PPLN device with d_{eff}=12 pm/V. These numbers are realistic with current state of art for 1.06 and 1.45 micron lasers.

The cavity configuration in our invention can be linear, or folded linear, or ring with a high Q value of 50 or more at the signal wavelength. The cavity might be formed by separate mirrors, or mirrors deposited to the facets of the gain medium and nonlinear crystals. The laser crystal facets might be anti-reflection coated at 1450 and 1064 nm, or the crystal might be placed at Brewster's angle to suppress loss associated with Fresnel reflection. Lasing gain medium and nonlinear crystals might be separate or bonded to each other. Moreover, a Cr co-doped crystal such as PPLN or PPLT might be used as a gain media and nonlinear crystal at the same time. The cavity might include, depending on the particular embodiment, other elements for controlling polarization state, bandwidths, directivity, and beam quality control such as waveplates, polarizers, etalons, irises, isolators etc or extra active and nonlinear crystals. The DFG crystal could be either periodically poled or not, depending on the output power and efficiency requirements. A non-poled DFG crystal may be critically or non-critically phase matched.

It should be noted that the laser designs of the present invention are fundamentally different from the scheme presented in FIG. 2 with a resonant cavity. Although DFG process provides gain for the signal wavelength and intracavity laser power build-up occurs in such a cavity, it only works in a CW regime or low repletion rate with pulsed pump train with constant pulse period. Since the communication signal is not a fully periodical pulse train but a subsequence of pulses (1) and no-pulses (0) the system from FIG. 2 cannot generate arbitrary digital sequences and thus it is not suitable for high-speed communications. In embodiments of the present invention the cavity is always filled with a high-power CW signal radiation, so the generated 4 μm light is modulated in the same manner as pump light.

Since it was demonstrated that operation wavelength of the Cr:YAG laser can be tuned from ˜1350 to 1550 nm by an intracavity birefringent filter, our proposed laser source can be tuned in the whole 3.8-4.1 micron range with the pump at 1064 nm. However, to reach the same idler range, any pump laser from 1000-1150 nm range could be used. To provide phase-matching at different wavelengths the DFG device with multiple gratings stacked side by side, or so called fanout DFG (where period continuously changes across crystal width) can be used. Then, for each required wavelength the DFG device will be moved to an appropriate position at which phase-matching condition is satisfied.

In some embodiments, the present invention features a laser system for generating high-speed modulated light using difference frequency generation (DFG). A single pump light source may pump both a signal crystal and a DFG device. As a non-limiting example, the system may include: an optical resonator, a pump light source external to the optical resonator, a gain crystal for signal and a DFG device each positioned within the optical resonator, and a modulator configured to modulate the pump light.

In preferred embodiments, the optical resonator may have a Q factor greater than about 50 for a wavelength in the range between 1350 and 1550 nm. As the signal crystal may be configured to be pumped by the pump light to emit a signal light with a wavelength in the range between 1350 and 1550, the optical resonator may be designed to circulate the signal light. In some embodiments, the pump light source may be configured to emit a pump light with a wavelength in the range between 1000 and 1150 nm. The DFG device may be positioned within the optical resonator such that the pump light and the signal light are configured to pass collinearly through the DFG device. As such, the DFG device may be configured to generate an idler light with an optical frequency equal to the difference between the frequencies of the pump light and the signal light. This idler light may then be the high-speed modulated light of interest.

According to preferred embodiments, the signal crystal may be a Cr:YAG crystal. The DFG device may be a non-linear crystal, for example, a periodically poled non-linear crystal. Non-limiting examples of DFG devices include periodically poled lithium niobate (PPLN), periodically poled lithium tantalate (PPLT), periodically poled potassium titanyl phosphate (PPKTP), cadmium silicon phosphide (CSP), zinc germanium phosphide (ZGP), and orientation-patterned gallium arsenide (OP—GaAs).

The system may include a tuning element within the optical resonator, the tuning element configured to tune the wavelength of the signal light within the optical resonator. This tuning element may allow for generation of a range of desired output wavelengths from a fixed pump wavelength. For example, in order to get a 4100 nm output from a 1064 nm pump, Cr:YAG has to be forced to lase at 1437 nm. This may be accomplished by means of the tuning element, which may be configured to choose the signal wavelength from a range between about 1350 to 1550 nm. As a non-limiting example, the tuning element may be a tuning plate (birefringent filter).

In some embodiments, the system may use a single non-linear crystal instead of separate signal crystal and DFG devices. As a non-limiting example, a nonlinear crystal co-doped with Cr may be capable of amplifying a signal wavelength without a separate gain medium. In some embodiments, the signal crystal comprises a Cr-doped crystal, glass, or ceramic.

The optical resonator may have any suitable configuration. As non-limiting examples, the optical resonator may have a linear, folded linear, or ring cavity configuration. The optical resonator may include mirrors which are distinct from gain media and crystal surfaces. Alternatively, the optical resonator may include mirrors which are deposited on a gain media and or a non-linear crystal.

In some embodiments, the laser system for generating high-speed modulated light using difference frequency generation (DFG) may use two separate wavelengths from a single pump light source to pump a signal crystal and a DFG device. As a non-limiting example, the system may include: an optical resonator having a Q factor greater than about 50 for a wavelength in the range between 1350 and 1550 nm; a first pump light source external to the optical resonator, configured to emit a first pump light with a wavelength in the range between 1000 and 1150 nm and a second pump light with a wavelength in the range between 1000 and 1150 nm and different from that of the first pump light; a modulator configured to modulate the first pump light; a signal crystal within the optical resonator, configured to be pumped by the second pump light to emit a signal light with a wavelength in the range between 1350 and 1550 nm; and a DFG device positioned within the optical resonator such that the pump light and the signal light are configured to pass collinearly through the DFG device, the DFG device configured to generate an idler light with an optical frequency equal to the difference between the frequencies of the first pump light and the signal light. The system may also include a splitter configured to split the first pump light and the second pump light into a first pump light path and a second pump light path. The system may include a first ytterbium-doped fiber amplifier (YDFA) in the first pump light path and a second ytterbium-doped fiber amplifier (YDFA) in the second pump light path. Alternatively, the system may include a ytterbium-doped fiber amplifier (YDFA) configured to amplify both the first pump light and the second pump light before they are split by the splitter. The optical resonator may have a linear, folded linear, or ring cavity configuration.

According to some embodiments, the laser system for generating high-speed modulated light using difference frequency generation (DFG) may include multiple pump light sources to separately pump the signal crystal and the DFG device. As a non-limiting example, the system may include: an optical resonator having a Q factor greater than about 50 for a wavelength in the range between 1350 and 1550 nm; a first pump light source external to the optical resonator, configured to emit a first pump light with a wavelength in the range between 1000 and 1150 nm; a modulator configured to modulate the first pump light; a second pump light signal external to the optical resonator, configured to emit a second pump light with a wavelength in the range between 900 and 1150 nm; a signal crystal within the optical resonator, configured to be pumped by the second pump light to emit a signal light with a wavelength in the range between 1350 and 1550 nm; and a DFG device positioned within the optical resonator such that the pump light and the signal light are configured to pass collinearly through the DFG device, the DFG device configured to generate an idler light with an optical frequency equal to the difference between the frequencies of the first pump light and the signal light. In some embodiments, the first pump light and the second pump light may have different wavelengths.

As used herein, the term “about” refers to plus or minus 10% of the referenced number.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A laser system for generating high-speed modulated light using difference frequency generation (DFG), the system comprising:
a. an optical resonator having a Q factor greater than about 50 for a wavelength in the range between 1350 and 1550 nm;
b. a pump light source external to the optical resonator, configured to emit a pump light with a wavelength in the range between 1000 and 1150 nm;
c. a signal crystal within the optical resonator, configured to be pumped by the pump light to emit a signal light with a wavelength in the range between 1350 and 1550 nm;
d. a modulator configured to modulate the pump light; and
e. a DFG device positioned within the optical resonator such that the pump light and the signal light are configured to pass collinearly through the DFG device, the DFG device configured to generate an idler light with an optical frequency equal to the difference between the frequencies of the pump light and the signal light.

2. The system of claim 1, wherein the signal crystal comprises a Cr:YAG crystal.

3. The system of claim 1, wherein the DFG device comprises a non-linear crystal.

4. The system of claim 3, wherein the non-linear crystal is periodically poled.

5. The system of claim 3, wherein the non-linear crystal comprises periodically poled lithium niobate (PPLN), periodically poled lithium tantalate (PPLT), periodically poled potassium titanyl phosphate (PPKTP), cadmium silicon phosphide (CSP), zinc germanium phosphide (ZGP), or orientation-patterned gallium arsenide (OP—GaAs).

6. The system of claim 1, additionally comprising a tuning element within the optical resonator, the tuning element configured to tune the wavelength of the signal light within the optical resonator.

7. The system of claim 1, wherein the signal crystal and the DFG device comprise a single nonlinear crystal co-doped with Cr and capable of amplifying the signal light.

8. The system of claim 1, wherein the lasing crystal for signal comprises a Cr-doped crystal, glass, or ceramic.

9. The system of claim 1, wherein the optical resonator comprises a linear, folded linear, or ring cavity configuration.

10. The system of claim 1, additionally comprising a birefringent filter tuning element within the optical resonator.

11. The system of claim 10, wherein the tuning element comprises a tuning plate.

12. The system of claim 1, wherein the optical resonator comprises mirrors which are distinct from gain media and crystal surfaces.

13. The system of claim 1, wherein the optical resonator comprises mirrors which are deposited on a gain media and or a non-linear crystal.

14. A laser system for generating high-speed modulated light using difference frequency generation (DFG), the system comprising:
a. an optical resonator having a Q factor greater than about 50 for a wavelength in the range between 1350 and 1550 nm;
b. pump light source external to the optical resonator, configured to emit a first pump light with a wavelength in the range between 1000 and 1150 nm and a second pump light with a wavelength in the range between 1000 and 1150 nm and different from that of the first pump light;
c. a modulator configured to modulate the first pump light;
d. a signal crystal within the optical resonator, configured to be pumped by the second pump light to emit a signal light with a wavelength in the range between 1350 and 1550 nm; and
e. a DFG device positioned within the optical resonator such that the pump light and the signal light are configured to pass collinearly through the DFG device, the DFG device configured to generate an idler light with an optical frequency equal to the difference between the frequencies of the first pump light and the signal light.

15. The system of claim 14, additionally comprising a splitter configured to split the first pump light and the second pump light into a first pump light path and a second pump light path.

16. The system of claim 15, additionally comprising a first ytterbium-doped fiber amplifier (YDFA) in the first pump light path and a second ytterbium-doped fiber amplifier (YDFA) in the second pump light path.

17. The system of claim 15, additionally comprising a ytterbium-doped fiber amplifier (YDFA) configured to amplify both the first pump light and the second pump light before they are split by the splitter.

18. The system of claim 14, wherein the optical resonator comprises a linear, folded linear, or ring cavity configuration.

19. A laser system for generating high-speed modulated light using difference frequency generation (DFG), the system comprising:
a. an optical resonator having a Q factor greater than about 50 for a wavelength in the range between 1350 and 1550 nm;
b. a first pump light source external to the optical resonator, configured to emit a first pump light with a wavelength in the range between 1000 and 1150 nm;
c. a modulator configured to modulate the first pump light;
d. a second pump light signal external to the optical resonator, configured to emit a second pump light with a wavelength in the range between 900 and 1150 nm;
e. a signal crystal within the optical resonator, configured to be pumped by the second pump light to emit a signal light with a wavelength in the range between 1350 and 1550 nm; and
f. a DFG device positioned within the optical resonator such that the pump light and the signal light are configured to pass collinearly through the DFG device, the DFG device configured to generate an idler light with an optical frequency equal to the difference between the frequencies of the first pump light and the signal light.

20. The system of claim 19, wherein the first pump light and the second pump light have different wavelengths.
